(19) United States
(12) Patent Application Publication
(10) Pub. No.: US 2014/0247710 A1
(43) Pub. Date: Sep. 4, 2014

(54) PROACTIVE REDIRECTION OF TRAFFIC DURING LOW VOLTAGE (BROWNOUT) CONDITION AND PREFERENTIAL TREATMENT OF HIGH PRIORITY TRAFFIC

(71) Applicant: CISCO TECHNOLOGY, INC., San Jose, CA (US)

(72) Inventors: Joel Goergen, Soulsbyville, CA (US); Robert Curto, Port Charlotte, FL (US); Jay Karthik, Rutherford, NJ (US); Andrew Naumov, San Francisco, CA (US)

(73) Assignee: CISCO TECHNOLOGY, INC., San Jose, CA (US)

(21) Appl. No.: 13/783,381

(22) Filed: Mar. 3, 2013

(51) Int. Cl. H04L 12/24

(52) U.S. Cl. CPC H04L 41/0668
USPC 370/221

(57) ABSTRACT

A methodology is described such that when a brownout condition is being experienced by a network node, the network node may autonomously notify the adjacent nodes to reroute the traffic for different classes of service based on programmable low voltage thresholds. The present approach helps lower transit traffic disruption while providing a framework to give preferential treatment to high priority traffic traversing the node.

### BACKGROUND

Operating systems, including the IOS XR operating system from CISCO SYSTEMS™, may monitor the input voltage to a given system, such as a Carrier Routing System from CISCO SYSTEMS™. A number of voltage thresholds may be established in such systems. When the input voltage drops below a threshold, appropriate log messages may be generated.

Service providers are constantly looking for ways to reduce service outages in their network. It currently requires heavy investment in hardware and software systems to improve the reliability of the network. The problem with such prior art approaches is that these fail to employ existing hardware to provide a solution for redirecting traffic when the input voltage drops below a threshold.

### BRIEF DESCRIPTION OF THE DRAWINGS

The accompanying drawings, which are incorporated in and constitute a part of this disclosure, illustrate various embodiments. In the drawings:

FIG. 1 illustrates an example network environment for embodiments of this disclosure;

FIG. 2 is a flow chart illustrating embodiments of this disclosure;

FIG. 3 is a flow chart illustrating embodiments of this disclosure; and

FIG. 4 is a block diagram of a computing network device.

### DETAILED DESCRIPTION OF EXAMPLE EMBODIMENTS

### Overview

Consistent with embodiments of the present disclosure, systems and methods are disclosed for providing proactive redirection of traffic during low voltage conditions, while still abiding to the preferential treatment of high priority traffic.

In some embodiments, a method of directing data traffic is described comprising: monitoring an input voltage at a first network node; and providing a first message to a plurality of neighboring nodes when the input voltage of the first network node drops below a first threshold, wherein the first message provides information such that the plurality of neighboring nodes bypass the first network node when transmitting a first data flow.

In some embodiments, a method of directing data traffic is described comprising: monitoring input voltage to a plurality of network nodes; detecting that input voltage to a first network node of the plurality of network nodes has dropped below a first threshold; and routing only high priority data traffic to network nodes other than the first network node.

In some embodiments, a network device is described comprising: a memory containing executable instructions for causing a processor to perform operations comprising: establishing voltage levels corresponding to a minor threshold, a major threshold, and a critical threshold; monitoring input voltage to a plurality of network devices; detecting that the input voltage of a first network device of the plurality of network devices has crossed one of the minor threshold, the major threshold, and the critical threshold; and altering the path of a first data flow based on which of the minor threshold, the major threshold, and the critical threshold was crossed and the priority level of the first data flow.

It is to be understood that both the foregoing general description and the following detailed description are examples and explanatory only, and should not be considered to restrict the application's scope, as described and claimed. Further, features and/or variations may be provided in addition to those set forth herein. For example, embodiments of the present disclosure may be directed to various feature combinations and sub-combinations described in the detailed description.

### EXAMPLE EMBODIMENTS

The following detailed description refers to the accompanying drawings. Wherever possible, the same reference numbers are used in the drawings and the following description to refer to the same or similar elements. While embodiments of this disclosure may be described, modifications, adaptations, and other implementations are possible. For example, substitutions, additions, or modifications may be made to the elements illustrated in the drawings, and substituting, reordering, or adding stages to the disclosed methods may modify the methods described herein. Accordingly, the following detailed description does not limit the disclosure. Instead, the proper scope of the disclosure is defined by the appended claims.

Embodiments of the present disclosure describe a methodology such that when a brownout condition is being experienced by a network node, the network node may autonomously notify the adjacent nodes to reroute the traffic for different classes of service based on programmable low voltage thresholds. The present approach helps lower transit traffic disruption while providing a framework to give preferential treatment to high priority traffic traversing the node.

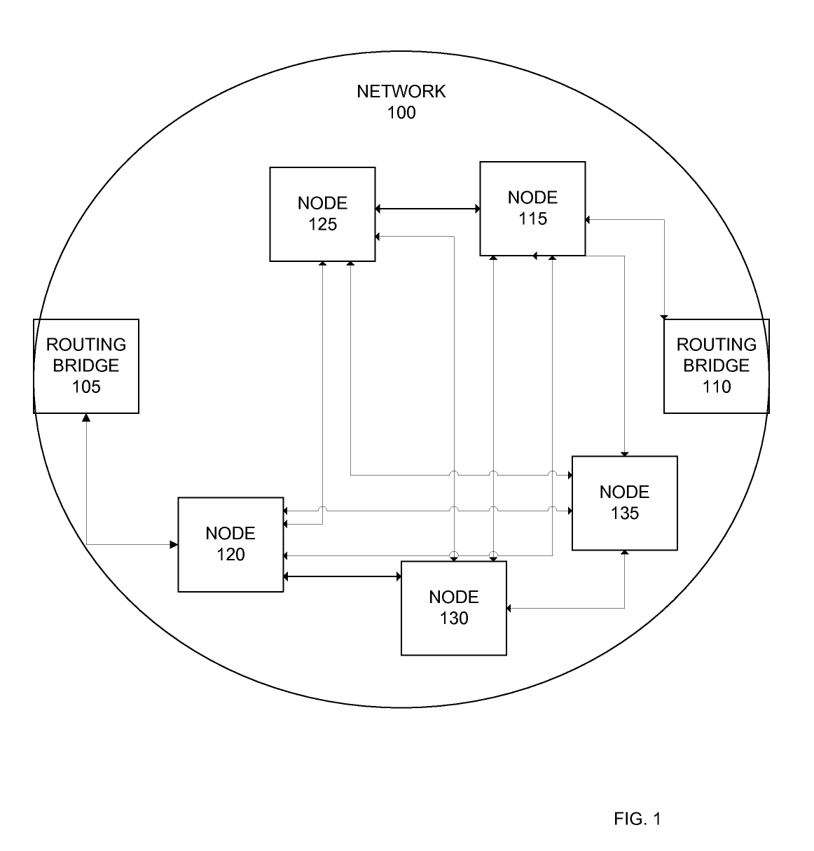

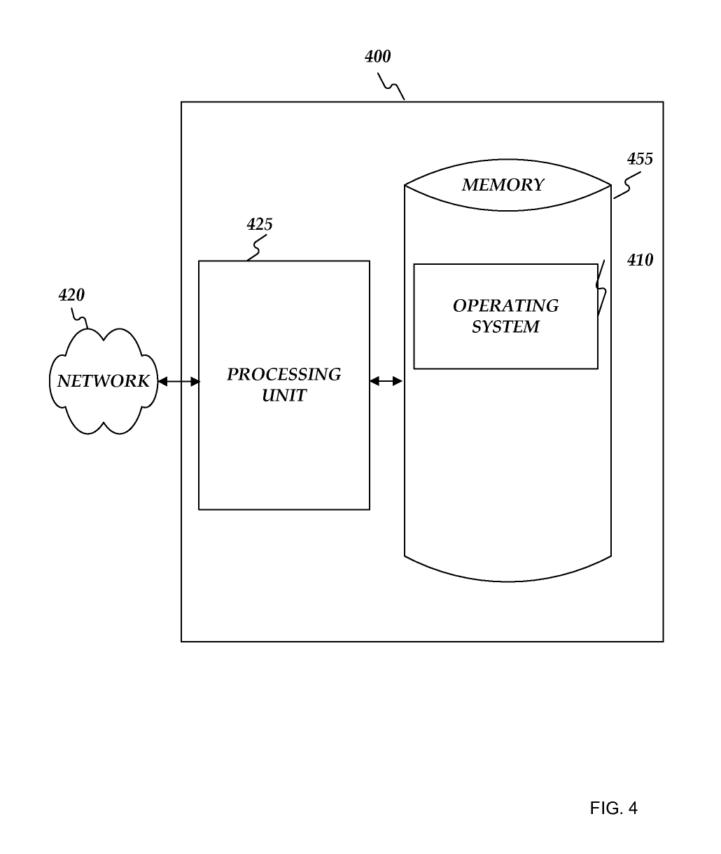

Referring to FIG. 1, an example of a network 100 in which embodiments described herein may be implemented is shown. The embodiments described herein may operate in the context of a data communication network including multiple network devices. Some of the devices in the network may be routing bridges, switches, bridges, routers, gateways, or other network devices. In some embodiments, the network device is implemented on a general purpose machine as described below with respect to FIG. 4.

In some embodiments, network 100 may be a network with one or more of the network devices being routing bridges. The network 100 shown in FIG. 1 includes routing bridge 105 and routing bridge 110 located at an edge of network 100. Network 100 may further include a plurality of internal routers 115, 120, 125, 130, 135. Routing bridge 105 and routing bridge 110 (also referred to as “edge routers”) may operate as ingress and egress nodes, respectively, for a flow entering network 100 at routing bridge 105 and leaving the network respectively at routing bridge 110, for example. Throughout the present specification network devices, such as routers, may be referred to generically as “nodes” within a network. For purposes of examples in the present disclosure, network device 120 may be an example headend device as used in below discussions.

In embodiments of the present disclosure, multiple voltage thresholds may be established. For example, a minor threshold may be set to (−44 V). A major threshold may be set to (−42V). Similarly, a critical threshold may be set to (−40V). It should be understood that while the present disclosure describes the thresholds in the above terms, the invention is not so limited and the number and values of thresholds may be determined as is appropriate for the implementing system.

When the input voltage drifts below the major threshold, the node is presumed to subsequently lose power. As such, a procedure to cost-out the router from the network using existing Layer-3 mechanism may be self-initiated. In some embodiments, a procedure may be put in place to send higher Interior Gateway Protocol (“IGP”) metrics or other NM messages that would allow neighbors to bypass the effected node for transit traffic intended for the node experiencing the low voltage condition.

The input voltage may subsequently continue to drop and pass below the critical threshold. Here, the priority of the costing out procedure may be increased to the highest available priority level. In the scenario where the input voltage returns to a higher level of voltage (normal operation) during the costing out procedure, the node (router) may refresh with normal routing cost metrics so that the adjacent nodes may now start transiting traffic through the local node. In the case where the node completely loses power and shuts down, the cost-out procedure may be completed. When power is restored, and the node re-stabilizes traffic may be re-routed back to its original node, slot, and port.

In a scenario where the input voltage drifts below the minor threshold, high priority traffic may be moved out of the node experiencing low voltage conditions. This is regardless of the fact that the node may still have sufficient power to remain functional and operating. This prevents a worst case scenario where the voltage may drop below a critical threshold. In some embodiments, this may be accomplished through the use of Multiprotocol Label Switching traffic engineering functionality (soft preemption). The node experiencing a low voltage condition may notify headends of a high priority tunnel using extensions.

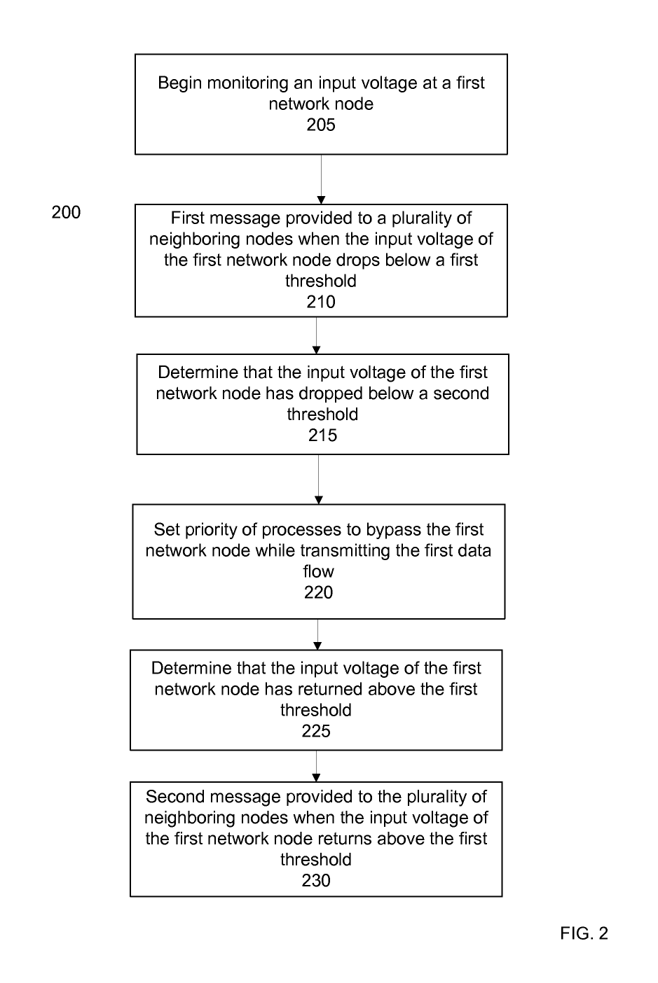

FIG. 2 is a flow chart illustrating operation of embodiments of the present disclosure for directing data traffic during reduced power input conditions. Method 200 may begin at step 205 where a system may begin monitoring an input voltage at a first network node.

Next, at step 210, a first message may be provided to a plurality of neighboring nodes when the input voltage of the first network node drops below a first threshold. In some embodiments, this first threshold corresponds with the major threshold as discussed above. The first message may provide information such that the plurality of neighboring nodes may learn to bypass the first network node when transmitting a first data flow.

In some embodiments of the present disclosure, the first data flow contains best-effort priority data. Such traffic may be treated as the default level of traffic. As the data flow contains best-effort priority data, method 200 may proceed to step 215. At step 215, it may be determined that the input voltage of the first network node has dropped below a second threshold. In some embodiments, this second threshold corresponds with the critical threshold as discussed above. Furthermore, in some embodiments the first threshold may be set to −42V and the second threshold may be set to −40V.

After determining that the input voltage of the first network node has dropped below the second threshold, method 200 may proceed to step 220. At step 220, the priority of processes to bypass the first network node while transmitting the first data flow may be set to the highest available level.

Later, method 200 may proceed to step 225 where it may be determined that the input voltage of the first network node has returned above the first threshold. Next, at step 230, a second message may be provided to the plurality of neighboring nodes when the input voltage of the first network node returns above the first threshold. The second message may provide information such that the neighboring nodes stop bypassing the first network node when transmitting the first data flow. In some embodiments of the present disclosure, the first message and the second message contain IGP metric information.

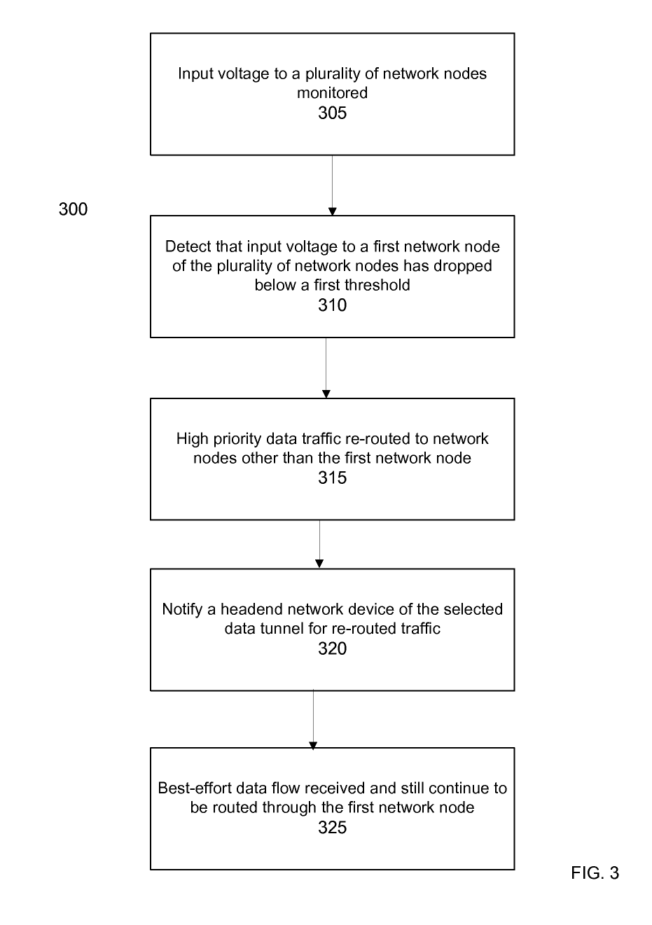

FIG. 3 is a flow chart illustrating operation of embodiments of the present disclosure for directing data traffic during reduced power input conditions. Method 300 may begin at step 305 where input voltage to a plurality of network nodes may be monitored. Next, at step 310, it may be detected that input voltage to a first network node of the plurality of network nodes has dropped below a first threshold. In some embodiments, the first threshold may be the minor threshold as discussed above. The minor threshold may be set at −44V.

After detection of the input voltage dropping, method 300 may proceed to step 315. At step 315, all high priority data traffic may be re-routed to network nodes other than the first network node. In some embodiments of the present disclosure, the plurality of nodes may reside on a Layer-3 network.

Re-routing the network traffic may include selecting a data tunnel for routing the high priority data based on Multiprotocol Label Switching Traffic Engineering metrics. As such, method 300 may proceed to step 320 and notify a headend network device of the selected data tunnel for re-routed traffic. Such a notification may be provided through the use of Resource Reservation Protocol (“RSVP”) extensions.

In some embodiments of the present disclosure, method 300 may proceed to step 325. At step 325, a best-effort data flow may be received and still continue to be routed through the first network node.

FIG. 4 illustrates a computing device 400, such as a server, host, or other network devices described in the present specification. Computing device 400 may include processing unit 425 and memory 455. Memory 455 may include software configured to execute application modules such as an operating system 410. Computing device 400 may execute, for example, one or more stages included in the methods as described above. Moreover, any one or more of the stages included in the above describe methods may be performed on any element shown in FIG. 4.

Computing device 400 may be implemented using a personal computer, a network computer, a mainframe, a computing appliance, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal. The aforementioned systems and devices are examples and the processor may comprise other systems or devices.

Embodiments of the present disclosure, for example, are described above with reference to block diagrams and/or operational illustrations of methods, systems, and computer program products according to embodiments of this disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and are the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

What is claimed is:

1. A method of directing data traffic comprising:
monitoring an input voltage at a first network node; and
providing a first message to a plurality of neighboring nodes when the input voltage of the first network node drops below a first threshold, wherein the first message provides information such that the plurality of neighboring nodes bypass the first network node when transmitting a first data flow.

2. The method of claim 1, wherein the first data flow contains best-effort priority data.

3. The method of claim 2, further comprising:
increasing the priority of processes to bypass the first network node while transmitting the first data flow when the input voltage of the first network node drops below a second threshold.

4. The method of claim 3, wherein the second threshold is set to a voltage level lower than that a voltage level associated with the first threshold.

5. The method of claim 4, further comprising:
providing a second message to the plurality of neighboring nodes when the input voltage of the first network node returns above the first threshold, wherein the second message provides information such that the plurality of neighboring nodes stop bypassing the first network node when transmitting the first data flow.

6. The method of claim 5, wherein the first threshold is −42V and the second threshold is −40V.

7. The method of claim 5, wherein the first message and the second message contain Interior Gateway Protocol metric information.

8. A method of directing data traffic comprising:
monitoring input voltage to a plurality of network nodes;
detecting that input voltage to a first network node of the plurality of network nodes has dropped below a first threshold; and
routing only high priority data traffic to network nodes other than the first network node.

9. The method of claim 8, wherein the plurality of nodes reside on a Layer-3 network.

10. The method of claim 9, further comprising:
selecting a data tunnel for routing the high priority data based on Multiprotocol Label Switching Traffic Engineering metrics.

11. The method of claim 10 further comprising:
notifying a headend network device of the selected data tunnel.

12. The method of claim 11, wherein the notification is provided through the use of Resource Reservation Protocol extensions.

13. The method of claim 11, further comprising:
routing best-effort data traffic through the first network node.

14. A network device comprising:
a memory containing executable instructions for causing a processor to perform operations comprising:
establishing voltage levels corresponding to a minor threshold, a major threshold, and a critical threshold;
monitoring input voltage to a plurality of network devices;
detecting that the input voltage of a first network device of the plurality of network devices has crossed one of the minor threshold, the major threshold, and the critical threshold; and
altering the path of a first data flow based on which of the minor threshold, the major threshold, and the critical threshold was crossed and the priority level of the first data flow.

15. The network device of claim 14, the memory further comprising executable instructions for causing a processor to perform operations for:
detecting that the input voltage of the first network device of the plurality of network devices has crossed the minor threshold;
detecting that the priority level of the first data flow is best effort; and
continuing normal operation of the first data flow.

16. The network device of claim 14, the memory further comprising executable instructions for causing a processor to perform operations for:
detecting that the input voltage of the first network device of the plurality of network devices has crossed the major threshold;
detecting that the priority level of the first data flow is best effort; and
altering the first data flow to bypass the first network device.

17. The network device of claim 14, the memory further comprising executable instructions for causing a processor to perform operations for:
detecting that the input voltage of the first network device of the plurality of network devices has crossed the critical threshold;
detecting that the priority level of the first data flow is best effort;
altering the first data flow to bypass the first network device; and
raising the priority of the data flow bypass.

18. The network device of claim 14, the memory further comprising executable instructions for causing a processor to perform operations for:
detecting that the input voltage of the first network device of the plurality of network devices has crossed the minor threshold;
detecting that the priority level of the first data flow is high; and
altering the first data flow to bypass the first network device.

19. The network device of claim 14, wherein the network device is a designated routing bridge.

20. The network device of claim 14, the memory further comprising executable instructions for causing a processor to perform operations for:
altering the path of the first data flow based on Multiprotocol Label Switching Traffic Engineering metrics
